(19) United States
(12) Patent Application Publication
(10) Pub. No.: US 2019/0215370 A1
(43) Pub. Date: Jul. 11, 2019

(54) REMOTE VEHICLE TASK MANAGEMENT

(71) Applicant: GM GLOBAL TECHNOLOGY OPERATIONS LLC, Detroit, MI (US)

(72) Inventors: Shawn F. Granda, Novi, MI (US); Jeffrey J. Olsen, Royal Oak, MI (US)

(21) Appl. No.: 15/866,693

(22) Filed: Jan. 10, 2018

(51) Int. Cl. H04L 29/08; G06F 8/65; H04W 4/44; H04W 4/021; B60R 25/20

(52) U.S. Cl. CPC H04L 67/12; G06F 8/65; B60R 2325/10; H04W 4/021; B60R 25/209; H04W 4/44

(57) ABSTRACT

A system and method for executing vehicle tasks. The method carried out by the system includes: establishing one or more vehicle communication tasks, delaying execution of the one or more vehicle communication tasks; subsequently receiving a remote vehicle power activation command, and initiating at least one of the vehicle communication tasks in response to the remote vehicle power activation command prior to a vehicle drive event. An example system for executing vehicle tasks may include a remote server in communication with a vehicle. The remote server may be configured to communicate with the vehicle to implement one or more vehicle tasks, and to initiate at least one of the tasks in response to a user-initiated vehicle power activation command sent to the vehicle. The server may initiate the task(s) prior to a vehicle drive event.

### TECHNICAL FIELD

The present invention relates to systems and methods for executing or managing vehicle tasks, and more particularly to systems and methods for initiating vehicle tasks.

### BACKGROUND

Vehicle systems rely on an increasing number of software-based components. The increasing reliance upon software-based components has led to a growing need for regular updates to the components, in order to improve software performance, address bugs, or the like.

Vehicle data connections now allow updates to be obtained by the vehicle, often with little or no user intervention. For example, a vehicle may use a cellular or WiFi connection to download an update for a component, and may generally automatically install the update, without a user needing to initiate or even be aware of the update. In order to reduce battery drain, software updates are typically downloaded to a vehicle when the vehicle is running or, in the case of electric vehicles, connected to an auxiliary power source, e.g., for charging vehicle batteries. This results in a relatively narrow window of time when updates are most convenient to download. Moreover, as vehicle data systems are used increasingly during vehicle operation, overall bandwidth available for downloading updates when the vehicle is running relatively decreases.

### SUMMARY

In at least one example method of executing vehicle tasks, the method may include establishing one or more vehicle communication tasks, delaying execution of the one or more vehicle communication tasks; subsequently receiving a remote vehicle power activation command; and initiating at least one of the vehicle communication tasks in response to the remote vehicle power activation command prior to a vehicle drive event.

According to various embodiments, this method may further include any one of the following features or any technically-feasible combination of some or all of these features:
the offboard data connection is a WiFi network;
the tasks include at least one residence task, which may be at least one of opening a garage door and turning on a light;
the method may include the additional step of, in response to receiving the vehicle power activation command, determining a location of the vehicle; and optionally, selecting a subset of the one or more vehicle communication tasks, and initiating only the subset of vehicle communication tasks based upon the determined location of the vehicle, which location may optionally be determined using a geofence;
the remote vehicle power activation command may be received from a mobile communication device and the method may include the additional step of, in response to receiving the vehicle power activation command from the mobile communication device, determining a location of the mobile communication device, in which case the method may further comprise selecting a subset of the one or more vehicle communication tasks and initiating only the subset of vehicle communication tasks based upon the determined location of the mobile communication device;
the remote vehicle power activation command includes a remote vehicle start command; and/or
the at least one of the vehicle communication tasks includes downloading vehicle software to the vehicle.

In another example method of executing vehicle tasks, the method may include receiving a remote vehicle power activation command, and initiating a vehicle software download from an offboard data connection in response to the remote vehicle power activation command prior to a vehicle drive event.

In at least one example, a system for executing vehicle tasks may include a remote server in communication with a vehicle. The remote server may be configured to communicate with the vehicle to implement one or more vehicle tasks, and to initiate at least one of the tasks in response to a user-initiated vehicle power activation command sent to the vehicle. Moreover, the server may initiate the task(s) prior to a vehicle drive event.

According to various embodiments, this system may further include any one of the following features or any technically-feasible combination of some or all of these features:
the tasks include at least initiating a vehicle software download from a remote facility;
the vehicle is in communication with the remote server via a WiFi network;
the remote server is in communication with a mobile device, the mobile device configured to initiate the vehicle power activation command; and/or
the at least one of the vehicle tasks includes downloading vehicle software to the vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the exemplary methods disclosed herein;

FIG. 2 is a schematic diagram depicting an embodiment of a task management system that is capable of utilizing the exemplary methods disclosed herein; and

FIG. 3 is a process flow diagram illustrating exemplary methods of communicating with a vehicle.

### DETAILED DESCRIPTION OF THE ILLUSTRATED EMBODIMENT(S)

Exemplary illustrations are described herein of systems and methods for executing vehicle tasks. Vehicle tasks may take any form that is convenient, such as, merely by way of example, initiating software or firmware updates to vehicle equipment. In this manner, software or firmware updates may be completed or substantially so while the user is not in the vehicle or using data systems of the vehicle. Accordingly, bandwidth usage of the vehicle while driving, when a user such as a passenger may wish to use vehicle data systems to consume media, stream data to the vehicle, or the like, is reduced. Additionally, to the extent external data networks are available to the vehicle, such as a WiFi connection, such data networks may be used by the vehicle in implementing the task(s), thereby further reducing usage of vehicle data networks such as a vehicle cellular or data connection.

In other examples, vehicle tasks may include opening garage doors or turning on/off lights. In some examples, vehicle tasks or subsets of available tasks may be chosen based upon a geographic location of the vehicle. For example, upon receipt of a remote power activation command (e.g., a remote start command) from a user, a location of the vehicle and/or the user may be determined. Where the vehicle is determined to be in a garage of the user, a garage door may be opened, or lights of the home, e.g., within the garage or entryway areas, may be activated.

### Communications System

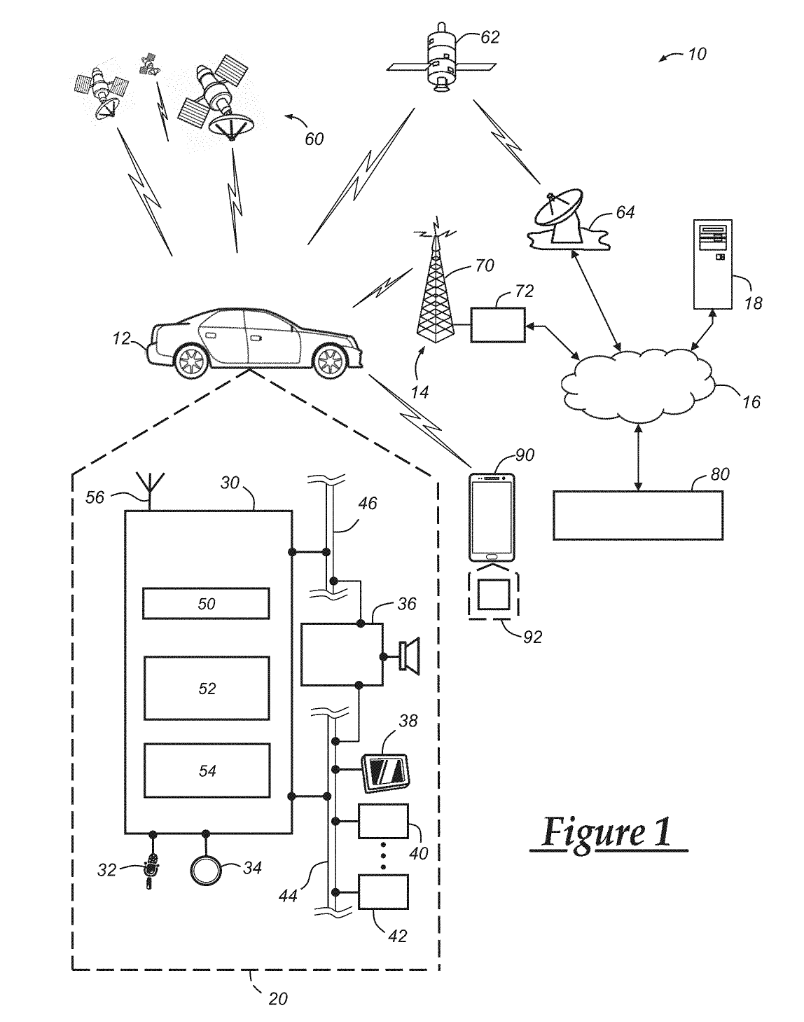

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, a remote facility 80, and a mobile device 90. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and include a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with remote facility 80, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art, or via other wireless communication methods, e.g., SMS/text messages. For combined services that involve both voice communication (e.g., with a live advisor or voice response unit at the remote facility 80) and data communication (e.g., to provide GPS location data or vehicle diagnostic data to the remote facility 80), the system can utilize a single call over a voice channel and switch as needed between voice and data transmission over the voice channel, and this can be done using techniques known to those skilled in the art.

According to one embodiment, telematics unit 30 utilizes cellular communication according to GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 18, for other purposes, such as fleet management. Also, new or updated map data can be downloaded to the GPS module 40 from the remote facility 80 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 20 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the remote facility 80. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to remote facility 80. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 80, or both. A computer 18 can also be used for providing Internet connectivity such as DNS services or as a network address server that uses DHCP or other suitable protocol to assign an IP address to the vehicle 12.

Remote facility 80 is designed to provide the vehicle electronics 20 with a number of different system back-end functions. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 16. A database at the remote facility can store account information such as subscriber authentication information, vehicle identifiers, profile records, behavioral patterns, and other pertinent subscriber information. Data transmissions may also be conducted by wireless systems, such as 882.11x, GPRS, and the like. Although the illustrated embodiment has been described as it would be used in conjunction with a manned remote facility 80 using a live advisor, it will be appreciated that the remote facility can instead utilize a VRS as an automated advisor or, a combination of the VRS and the live advisor can be used.

Mobile device 90 is a non-vehicle device, meaning that it is not a part of vehicle 12 or vehicle electronics 20. The mobile device includes: hardware, software, and/or firmware enabling cellular telecommunications and/or short range wireless communication (SRWC), as well as other wireless device functions and applications. The hardware of mobile device 90 comprises a processor and memory for storing the software, firmware, etc. This memory may include volatile RAM or other temporary powered memory, as well as a non-transitory computer readable medium (non-volatile RAM, ROM, etc.) that stores some or all of the software needed to carry out the various external device functions discussed herein. The mobile device processor and software stored in the memory enable various software applications, which may be preinstalled or installed by the user (or manufacturer) (e.g., having a software application or graphical user interface (GUI)). This may include an application 92 that can allow a vehicle user to communicate with vehicle 12 and/or to control various aspects or functions of the vehicle—e.g., among other things, allowing the user to remotely lock/unlock vehicle doors, turn the vehicle ignition on or off, check the vehicle tire pressures, fuel level, oil life, etc. The application may also be used to enable the user of device 90 to view information pertaining to the vehicle (e.g., the current location of the vehicle, whether the vehicle is locked or unlocked) and/or pertaining to an account associated with the user or vehicle. Wireless device 90 is shown as a smartphone having cellular telephone capabilities. In other embodiments, device 90 may be a tablet, laptop computer, or any other suitable device. In addition, application 92 may also allow the user to connect with the remote facility 80 or call center advisors at any time.

Accordingly, mobile device 90 may generally be used to send a command to the vehicle 12 to initiate vehicle tasks. In one example, vehicle tasks may be undertaken when a remote power activation command, e.g., a remote start command, is received at the vehicle 12. Additionally, the mobile device 90 may be used to manage tasks, e.g., to add/delete tasks from a menu of available tasks to be considered for implementation by the vehicle 12 upon receipt of a power activation command. The mobile device 90 may also be used to establish user preferences for the various tasks, e.g., geographic locations for the execution or prioritization of any of the tasks.

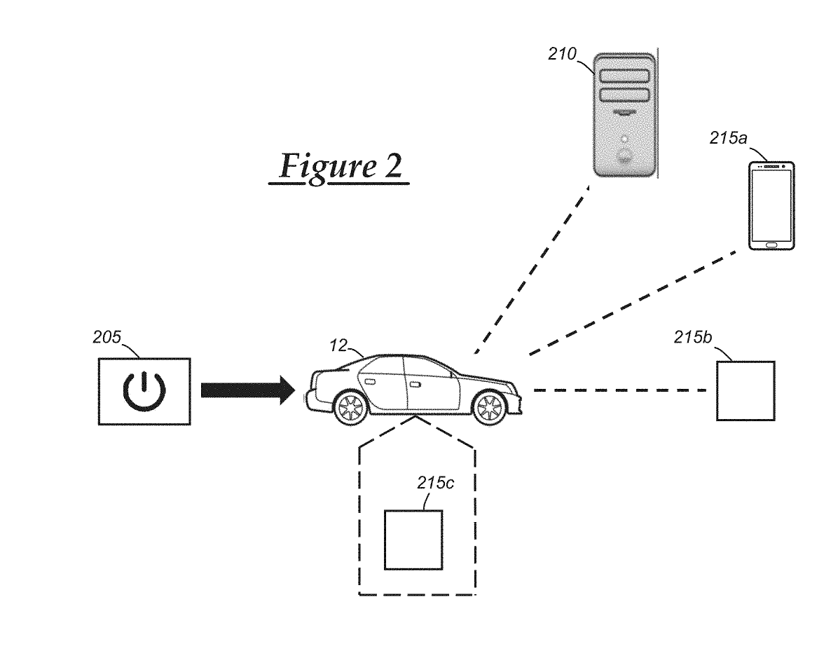

Turning now to FIG. 2, a schematic illustration of an example task management system is shown, which may be used in conjunction with the vehicle 12 illustrated in FIG. 1. As shown in FIG. 2, a vehicle power command 205 may be transmitted to vehicle 12 using any means that is convenient. Merely by way of example, exemplary power commands may include a remote start command that is transmitted by way of mobile device 90, the remote facility 80, a key fob of the vehicle 12, or the like.

Vehicle 12, as noted above, may generally communicate with systems that require updates to software or firmware, and implement tasks as part of external systems to the vehicle 12 or systems that are part of the vehicle 12. A device management server 210 may be provided to facilitate implementation of the task management system. For example, a user may set up lists of tasks or manage various tasks to be undertaken by the vehicle 12. More specifically, a user may interact with the device management server 210 by way of mobile device 90. The user may thereby set preferences for one or more tasks that may be controlled by way of the device management server 210.

Tasks implemented by the vehicle 12 in response to a power command 205 many include any vehicle tasks that are necessarily or conveniently carried out at that time. Generally, it may be advantageous to have the vehicle 12 undertake commands that involve communications with external systems. In one example, facility commands 215a may be undertaken by the vehicle 12. These commands may be associated with an external facility such as a user's home, garage, office, or the like. Merely by way of examples, example tasks of facility commands 215a may include opening or closing a garage door, or turning lights of a home or garage on or off. In another example described further below, when the vehicle 12 is determined to be positioned in a garage, one of the tasks may be to open a garage door. For example, this command may be convenient where a remote start is used to start the vehicle 12 and it is desirable to open the garage to prevent accumulation of exhaust gas in the garage. Alternatively, lighting may be activated or deactivated in response to a detection of the vehicle's 12 presence at a home or other location associated with the user.

Another set of exemplary tasks that may be implemented using the examples herein include third party application commands or updates 215b. For example, the mobile device 90 may be used in the vehicle 12 in a number of third party applications, for example, in conjunction with an audio or video system of the vehicle 12. These applications may require updates to be installed to vehicle 12. Accordingly, upon receipt of a power command 205, vehicle 12 may communicate with external data networks, e.g., by way of device management server 210, to obtain and/or install such updates.

Other example tasks may include vehicle software updates 215c. For example, the vehicle 12 itself may require software or firmware updates that must be downloaded and installed into vehicle electronics. Merely as examples, vehicle control modules, e.g., an engine control module, an infotainment system or components thereof, may require updates. These updates may be obtained via an external data network, e.g., a WiFi network, when available to the vehicle 12.

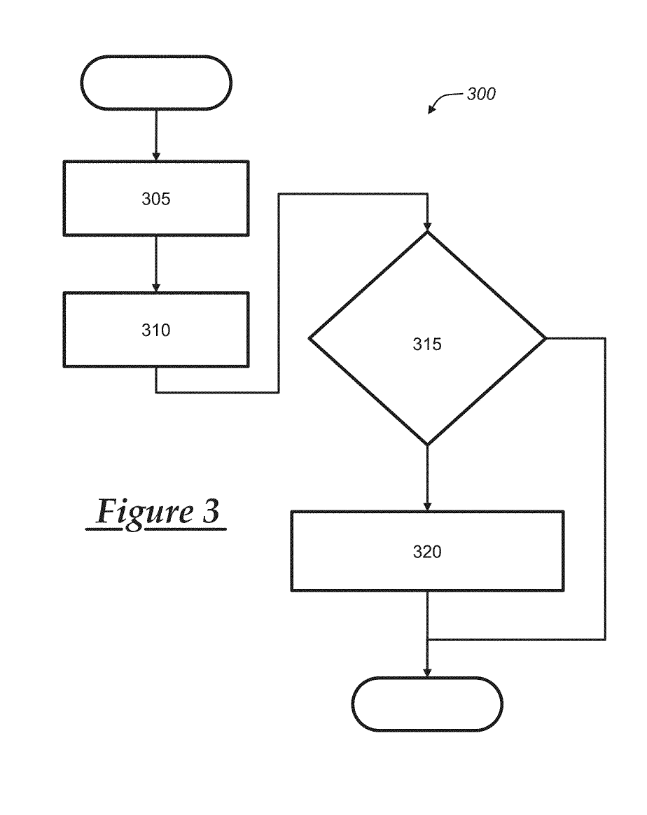

Turning now to FIG. 3, a process flow diagram illustrating example methods of executing vehicle tasks is shown. Process 300 may begin at block 305, where one or more vehicle communication tasks are established. For example, as noted above, a user may establish one or more tasks for a vehicle 12. Tasks may include downloading software from an external data network, e.g., by way of device management server 210, remote facility 80, or a WiFi network in communication with vehicle 12, merely as examples. In other examples, tasks may include facility-based tasks such as those associated with a user's home, office, or other associated locations. These facility-based tasks may include opening or closing garage doors, turning on or turning off lighting devices, or the like. Moreover, tasks may also be associated with a geographic location of the vehicle 12, and/or locations associated with the user of the vehicle 12. Merely as one example, the location of mobile device 90 may be used to establish a geographic location of the user and thereby determine whether or which tasks are implemented upon receipt of a power command. Once established, the execution of these tasks are then delayed pending receipt of a remote vehicle power activation command in step 310.

At block 310, a remote vehicle power activation command is received. For example, as noted above, vehicle 12 may receive a remote start command. These vehicle power activation commands may be received by any manner that is convenient. For example, as described above, a remote start command may be transmitted from a remote keyless entry device or key fob of the vehicle 12, from mobile device 90, from another computer, or the like. Additionally, remote vehicle power activation commands may include a supply of auxiliary power or off board power that is provided to the vehicle 12. For example, where vehicle 12 is an electric vehicle or is otherwise capable of receiving auxiliary power, the establishment of this auxiliary power, for example while the vehicle 12 is being charged, may allow the vehicle 12 to undertake tasks. Moreover, power activation commands may also be made contingent upon a detection of the availability of an external data network, such that any usage of data by the vehicle in implementing the tasks does not impact bandwidth usage of cellular or data networks associated with the vehicle 12.

Proceeding to block 315, process 300 determines whether there are any vehicle communication tasks pending that should be carried out. Some of the previously-established and delayed tasks from step 305 may be ones that can be automatically carried in response to the remote start command, whereas others may be conditional. For example, process 300 may determine whether one or more tasks should be undertaken given a location of the vehicle 12, a location of mobile device 90, or other indication of a location of the vehicle 12 or user. The one or more tasks determined for initiation may represent a subset of total commands that may be implemented by the vehicle 12, e.g., as may be appropriate based upon a relevant geographic location. Merely as one example, if the vehicle 12 is determined to be within a geofence area associated with a home or office of the user, tasks associated with those locations, e.g., turning on entryway lighting of the home, opening a garage door, etc., may be implemented based upon the location. Accordingly, the vehicle 12 may in some examples only implement commands where it is determined that the task is appropriate given the vehicle's 12 location. If process 300 determines there is a pending task to be initiated, process 300 proceeds to block 320. If the query result is that no tasks are appropriate, process 300 may then terminate.

Proceeding to block 320, the one or more pending vehicle communication tasks determined in step 315 to be appropriate for execution may now be implemented in response to the remote vehicle power activation command prior to a vehicle drive event. In some examples, the task may be implemented by way of an off board data connection such as a WiFi connection, e.g., to device management server 210. For example, the one or more tasks may be undertaken by way of an external data connection that does not use bandwidth-limited systems associated with the vehicle 12, e.g., a cellular or data network associated with the vehicle 12, and also does not draw power of the vehicle 12. Additionally, as noted above, the tasks may include one or more facility based tasks such as those associated with a home or office location of a user. Any of the different vehicle communication tasks discussed above that have been established (are pending) may be carried out at this step. Process 300 may then terminate.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of executing vehicle tasks, comprising the steps of:
(a) establishing one or more vehicle communication tasks;
(b) delaying execution of the one or more vehicle communication tasks;
(c) subsequently receiving a remote vehicle power activation command; and
(d) initiating at least one of the vehicle communication tasks via an offboard data connection in response to the remote vehicle power activation command prior to a vehicle drive event.

2. The method of claim 1, wherein the offboard data connection is a WiFi network.

3. The method of claim 1, wherein the tasks include at least one residence task.

4. The method of claim 3, wherein the at least one residence task includes at least one of opening a garage door and turning on a light.

5. The method of claim 1, further comprising the step:
(e) in response to receiving the vehicle power activation command in step (c), determining a location of the vehicle.

6. The method of claim 5, further comprising selecting a subset of the one or more vehicle communication tasks, and initiating only the subset of vehicle communication tasks based upon the location of the vehicle determined in step (e).

7. The method of claim 6, wherein the location of the vehicle is determined using a geofence.

8. The method of claim 1, wherein the remote vehicle power activation command is received from a mobile communication device.

9. The method of claim 8, further comprising the step:
(e) in response to receiving the vehicle power activation command from the mobile communication device, determining a location of the mobile communication device.

10. The method of claim 9, further comprising selecting a subset of the one or more vehicle communication tasks, and initiating only the subset of vehicle communication tasks based upon the location of the mobile communication device determined in step (e).

11. The method of claim 1, wherein the remote vehicle power activation command includes a remote vehicle start command.

12. The method of claim 1, wherein the at least one of the vehicle communication tasks includes downloading vehicle software to the vehicle.

13. A method of executing vehicle tasks, comprising the steps of:
(a) receiving a remote vehicle power activation command; and
(b) initiating a vehicle software download from an offboard data connection in response to the remote vehicle power activation command prior to a vehicle drive event.

14. A system for executing vehicle tasks, comprising:
a remote server in communication with a vehicle, the remote server configured to communicate with the vehicle to implement one or more vehicle tasks;
wherein the server is configured to initiate at least one of the tasks in response to a user-initiated vehicle power activation command sent to the vehicle, the server initiating the at least one of the tasks prior to a vehicle drive event.

15. The system of claim 14, wherein the tasks include at least initiating a vehicle software download from a remote facility.

16. The system of claim 14, wherein the vehicle is in communication with the remote server via a WiFi network.

17. The system of claim 14, wherein the remote server is in communication with a mobile device, the mobile device configured to initiate the vehicle power activation command.

18. The system of claim 14, wherein the at least one of the vehicle tasks includes downloading vehicle software to the vehicle.
